(19) United States
(12) Patent Application Publication
(10) Pub. No.: US 2023/0409630 A1
(43) Pub. Date: Dec. 21, 2023

(54) STORAGE MEDIUM, INFORMATION PROCESSING METHOD, AND INFORMATION PROCESSING DEVICE

(71) Applicant: Fujitsu Limited, Kawasaki-shi (JP)

(72) Inventor: Moyuru YAMADA, Bangalore (IN)

(73) Assignee: Fujitsu Limited, Kawasaki-shi (JP)

(21) Appl. No.: 18/176,809

(22) Filed: Mar. 1, 2023

(30) Foreign Application Priority Data
Jun. 15, 2022 (JP) 2022-096589

(51) Int. Cl. G06F 16/583

(52) U.S. Cl. CPC G06F 16/5846

(57) ABSTRACT

A non-transitory computer-readable storage medium storing an information processing program that causes at least one computer to execute a process, the process includes receiving, from a server, a plurality of pieces of first feature data that correspond to each of a plurality of pieces of image data; acquiring text data included in search conditions, the search conditions being transmitted from a client device; receiving second feature data that corresponds to the text data and is transmitted from the server, in response to transmitting the text data to the server; and acquiring a plurality of degrees of similarity between the plurality of pieces of the first feature data and the second feature data.

### CROSS-REFERENCE TO RELATED APPLICATION

This application is based upon and claims the benefit of priority of the prior Japanese Patent Application No. 2022-96589, filed on Jun. 15, 2022, the entire contents of which are incorporated herein by reference.

### FIELD

The embodiments discussed herein are related to a storage medium, an information processing method, and an information processing device.

### BACKGROUND

There are existing techniques 1, 2, 3, and the like as web services that find the degree of similarity between a sentence given by a user and a candidate image and return the found degree of similarity to the user. In the following, the existing techniques 1, 2, and 3 will be described in order.

First, the existing technique 1 will be described. FIG. 12 is a diagram for explaining the existing technique 1. FIG. 12 includes a user terminal 10, a user-side server 11a, and a service provider-side server 11b. When accepting input of a search sentence 5 from the user terminal 10, the server 11a transmits the search sentence 5 and a plurality of candidate images 6 held by the server 11a to the server 11b.

When receiving the search sentence 5 and the plurality of candidate images 6, the server 11b executes a degree-of-similarity computing program. By executing the degree-of-similarity computing program, the server 11b calculates a sentence vector of the search sentence 5 and respective image vectors of the plurality of candidate images 6 and computes the degree of similarity between the sentence vector and each image vector. This is how the server 11b computes the degrees of similarity between the search sentence 5 and the plurality of candidate images 6, and the server 11b transmits the degrees of similarity between the search sentence 5 and the plurality of candidate images 6 to the server 11a. The server 11a notifies the user terminal 10 of the degrees of similarity between the search sentence 5 and the plurality of candidate images 6 as processing results.

The server 11a repeatedly executes the above process every time input of the search sentence 5 is accepted from the user terminal 10 and receives the degrees of similarity between the search sentence 5 and the plurality of candidate images 6 from the server 11b.

Subsequently, the existing technique 2 will be described. FIG. 13 is a diagram for explaining the existing technique 2. FIG. 13 includes a user terminal 12, a user-side server 13a, and a service provider-side server 13b. The server 13a transmits a plurality of candidate images 6 held by the server 13a to the server 13b in advance. For example, the server 13b calculates respective image vectors I₁, I₂, I₃, . . . of the plurality of candidate images 6 and holds the respective calculated image vectors I₁, I₂, I₃, . . . .

When accepting input of a search sentence 5 from the user terminal 12, the server 13a transmits the search sentence 5 to the server 13b. When receiving the search sentence 5, the server 13b computes the sentence vector of the search sentence 5 and computes the degree of similarity between the computed sentence vector and each of the held image vectors I₁, I₂, I₃, . . . . This is how the server 13b computes the degrees of similarity between the search sentence 5 and the plurality of candidate images 6, and the server 13b transmits the ranking of the degrees of similarity between the search sentence 5 and the plurality of candidate images 6 to the server 13a. The server 13a notifies the user terminal 12 of the ranking of the degrees of similarity between the search sentence 5 and the plurality of candidate images 6 as processing results.

The server 13a repeatedly executes the above process every time input of the search sentence 5 is accepted from the user terminal 12 and receives the degrees of similarity between the search sentence 5 and the plurality of candidate images 6 from the server 13b.

Subsequently, the existing technique 3 will be described. FIG. 14 is a diagram for explaining the existing technique 3. FIG. 14 includes a user terminal 14 and a server 15 (user-side server). The server 15 is a server having the functions of the user-side server 13a and the service provider-side server 13b described with reference to FIG. 13. The server 15 calculates respective image vectors I₁, I₂, I₃, . . . of the plurality of candidate images 6 held by the server 15 and holds the respective calculated image vectors I₁, I₂, I₃, . . . .

When accepting input of the search sentence 5 from the user terminal 14, the server 15 computes the sentence vector of the search sentence 5 and computes the degree of similarity between the computed sentence vector and each of the held image vectors I₁, I₂, I₃, . . . . This is how the server 15 computes the degrees of similarity between the search sentence 5 and the plurality of candidate images 6, and the server 15 notifies the user terminal 14 of the ranking of the degrees of similarity between the search sentence 5 and the plurality of candidate images 6.

Japanese Laid-open Patent Publication No. 2013-65146 is disclosed as related art.

### SUMMARY

According to an aspect of the embodiments, a non-transitory computer-readable storage medium storing an information processing program that causes at least one computer to execute a process, the process includes receiving, from a server, a plurality of pieces of first feature data that correspond to each of a plurality of pieces of image data; acquiring text data included in search conditions, the search conditions being transmitted from a client device; receiving second feature data that corresponds to the text data and is transmitted from the server, in response to transmitting the text data to the server; and acquiring a plurality of degrees of similarity between the plurality of pieces of the first feature data and the second feature data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a process of an information processing system according to the present embodiment;

FIG. 2 is a functional block diagram illustrating a configuration of a user-side server according to the present embodiment;

FIG. 3 is a diagram illustrating an example of the data structure of a candidate image table;

FIG. 4 is a diagram illustrating an example of the data structure of a degree-of-similarity table;

FIG. 5 is a functional block diagram illustrating a configuration of a service provider-side server;

FIG. 6 is a flowchart illustrating a processing procedure of the user-side server according to the present embodiment;

FIG. 7 is a flowchart illustrating a processing procedure of the service provider-side server according to the present embodiment;

FIG. 8 is a diagram (1) illustrating another example of the information processing system;

FIG. 9 is a diagram (2) illustrating another example of the information processing system;

FIG. 10 is a diagram illustrating an example of the hardware configuration of a computer that implements functions similar to the functions of the user-side server according to the embodiment;

FIG. 11 is a diagram illustrating an example of the hardware configuration of a computer that implements functions similar to the functions of the service provider-side server according to the embodiment;

FIG. 12 is a diagram for explaining an existing technique 1;

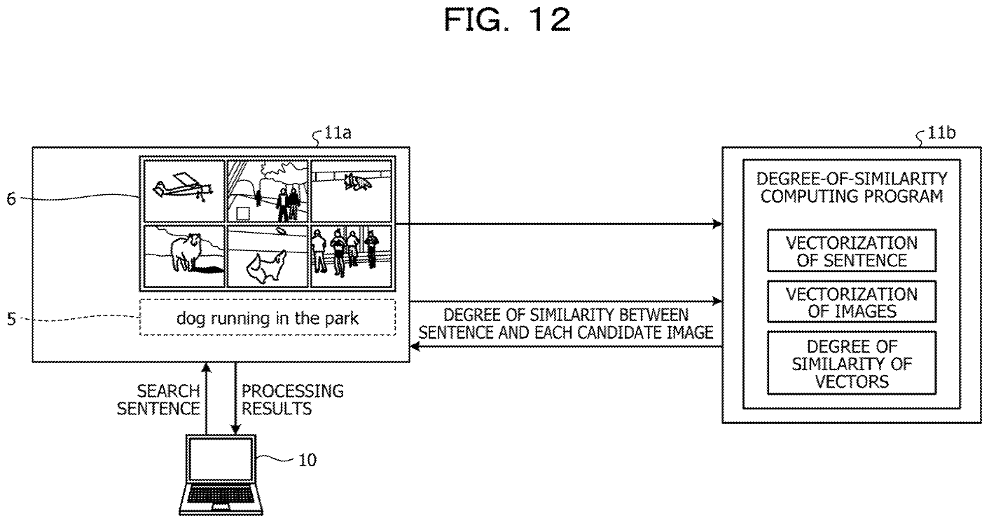

FIG. 13 is a diagram for explaining an existing technique 2; and

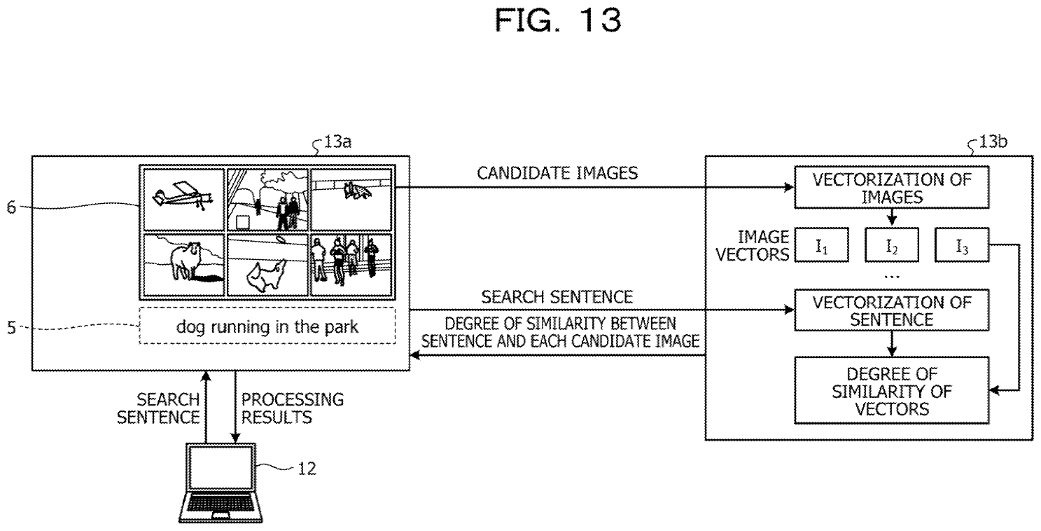

FIG. 14 is a diagram for explaining an existing technique 3.

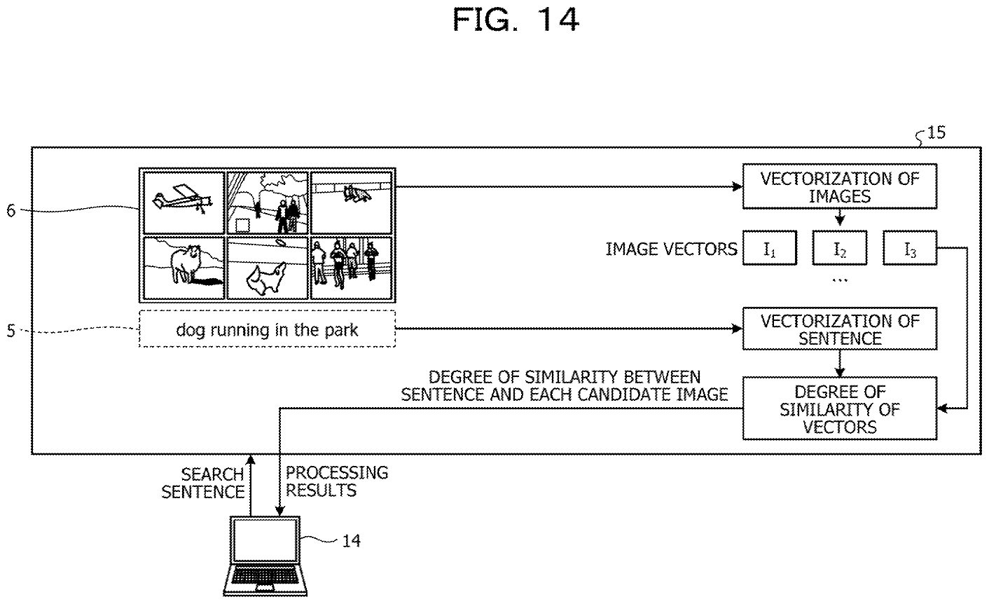

### DESCRIPTION OF EMBODIMENTS

For example, in the existing technique 1, since the server 11a transmits the search sentence 5 and the plurality of candidate images 6 to the server 11b every time input of the search sentence 5 is accepted from the user terminal 10, the network load is large. In addition, it takes time for the server 11a to receive the calculation results for the degree of similarity from the server 11b.

Here, in the existing technique 2, compared with the existing technique 1, the network load may be reduced, and the time until the computation results for the degree of similarity are received may be shortened. However, the server 13b will remain holding the image vectors of the plurality of candidate images 6. Since the original candidate image can sometimes be restored from the image vector, it is difficult to use the existing technique 2 when the candidate image contains user-side confidential information.

On the other hand, in the existing technique 3, since the user-side server 15 holds the image vectors of the plurality of candidate images 6, the existing technique 3 can be used even when the candidate images contain user-side confidential information. However, it is supposed that the user-side server 15 is provided with large-scale computational resources for vectorizing the search sentence 5 and the candidate images 6, and this increases the burden on the user in terms of the cost.

Therefore, it is demanded to efficiently calculate the degree of similarity of each candidate image to the search sentence input by the user. For example, when the degree of similarity of each candidate image to the search sentence input by a user is calculated, it is preferable to notify the user terminal of the processing results at high speed without preparing large-scale computational resources on the user-side server and without imposing a network load.

In one aspect, an object of the embodiments is to provide an information processing program, an information processing method, an information processing device, and an information processing system capable of efficiently executing computation of the degree of similarity between a search sentence and each candidate image.

Hereinafter, embodiments of an information processing program, an information processing method, an information processing device, and an information processing system disclosed in the present application will be described in detail with reference to the drawings. Note that the present embodiments are not limited to the following embodiments.

### EMBODIMENTS

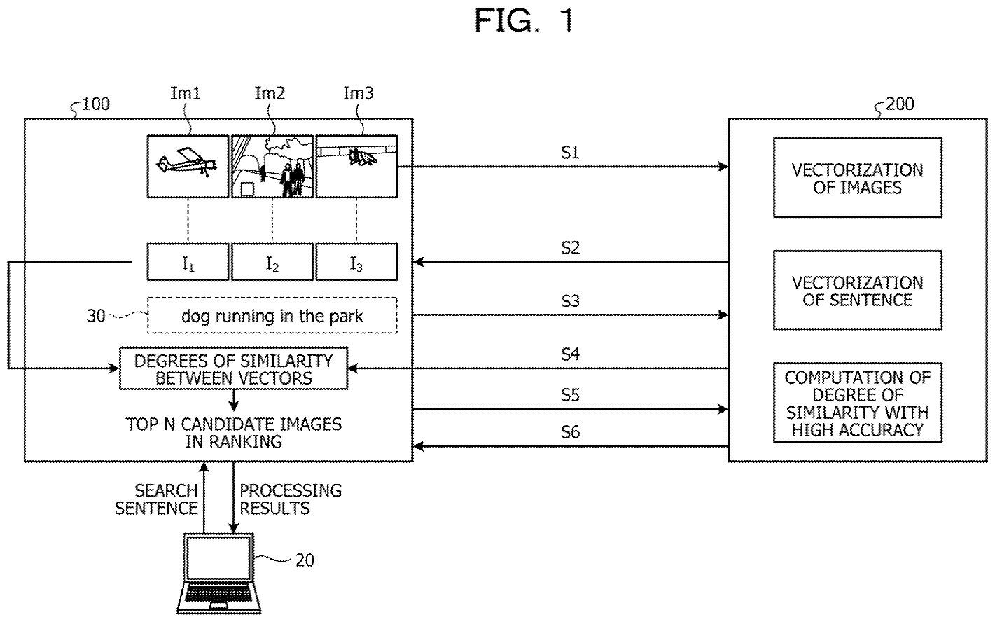

An example of the process of the information processing system according to the present embodiment will be described. FIG. 1 is a diagram for explaining a process of the information processing system according to the present embodiment. The information processing system illustrated in FIG. 1 includes a user terminal 20, a user-side server 100, and a service provider-side server 200.

The user terminal 20 and the server 100 are coupled to each other via a network. The server 100 and the server 200 are coupled to each other via a network. For example, the servers 100 and 200 perform the processes in steps S1 to S4 indicated below.

The server 100 holds candidate image data Im1, Im2, and Im3 and transmits the candidate image data Im1, Im2, and Im3 to the server 200 (step S1).

When receiving the candidate image data Im1, Im2, and Im3, the server 200 calculates image vectors I₁, I₂, and I₃ of the candidate image data Im1, Im2, and Im3. The server 200 transmits the image vectors I₁, I₂, and I₃ to the server 100 (step S2). After transmitting the image vectors I₁, I₂, and I₃ to the server 100, the server 200 deletes the image vectors I₁, I₂, and I₃ without saving the image vectors I₁, I₂, and I₃ in its own device (server 200).

When accepting input of search sentence data 30 from the user terminal 20, the server 100 transmits the search sentence data 30 to the server 200 (step S3).

When receiving the search sentence data 30, the server 200 calculates a sentence vector of the search sentence data 30 and transmits the calculated sentence vector to the server 100 (step S4). After transmitting the sentence vector to the server 100, the server 200 deletes the sentence vector without saving the sentence vector in its own device (server 200).

The server 100 calculates the degrees of cosine similarity between the image vectors I₁, I₂, and I₃ and the sentence vector of the search sentence data 30 and ranks the candidate image data Im1, Im2, and Im3 based on the degrees of similarity to notify the user terminal 20 of the ranking result.

For example, the degree of similarity between the image vector I₁ and the sentence vector is assumed as R1. The degree of similarity between the image vector I₂ and the sentence vector is assumed as R2. The degree of similarity between the image vector I₃ and the sentence vector is assumed as R3. Assuming that the magnitude relationship between the degrees of similarity is R3>R2>R1, the ranking of the candidate image data Im1, Im2, and Im3 results in the candidate image data Im3, the candidate image data Im2, and the candidate image data Im1 from the top. Although FIG. 1 illustrates only the candidate image data Im1, Im2, and Im3, the server 100 may have another plurality of pieces of candidate image data and may execute the above process on candidate image data including the another plurality of pieces of candidate image data to rank each piece of candidate image data.

As described above, the user-side server 100 prompts the server 200 to calculate the sentence vector when acquiring the search sentence data 30 as a search condition and receives the sentence vector notified by the server 200. The server 100 uses the received sentence vector and a plurality of image vectors acquired in advance from the server 200 to calculate the degrees of similarity between the search sentence data and the candidate image data and may achieve improvement in the efficiency of the calculation of the degree of similarity. For example, when the degree of similarity of each piece of candidate image data to the search sentence data is calculated, the user terminal 20 may be allowed to be notified of the processing results at high speed without preparing large-scale computational resources in the user-side server 100 and without imposing a network load.

Here, the servers 100 and 200 of the information processing system may perform the processes in S5 and S6 indicated below in addition to the above processes.

The server 100 selects pieces of the candidate image data from the highest rank to the N-th place, from among M pieces of candidate image data. Natural numbers are denoted by M and N, and M>N is assumed. The server 100 transmits the selected N pieces of candidate image data and the search sentence data 30 to the server 200 (step S5).

When receiving the N pieces of candidate image data and the search sentence data 30, the server 200 calculates each of the degrees of similarity between the N pieces of candidate image data and the search sentence data 30, by a process with higher accuracy than the accuracy of the process of the server 100, and transmits a plurality of degrees of similarity between the N pieces of candidate image data and the search sentence data 30 to the server 100 (step S6). The server 100 updates the degrees of similarity between the candidate image data from the highest rank to the N-th place and the sentence vector, with the degrees of similarity received from the server 200, and updates the ranking of each piece of candidate image data according to the updated degrees of similarity. The server 100 notifies the user terminal 20 of the updated ranking result.

For example, when computing the degree of similarity, the server 100 computes the degree of cosine similarity between the image vector of the candidate image data and the sentence vector of the search sentence data. Meanwhile, the server 200 calculates the degree of similarity between the candidate image data and the search sentence data, by inputting the candidate image data and the search sentence data to a trained training model (NN: neural network). The degree of cosine similarity has a low cost of computation, but has low accuracy compared with the calculation result for the degree of similarity by the training model. By performing the process as described above, the ranking result according to the degree of cosine similarity can be notified first, and the ranking result can be modified later according to the results of using the training model, which may allow the user terminal 20 to be notified of more precise information on the degree of similarity. Note that, to calculate the degree of similarity between the image vector of the candidate image data and the sentence vector of the search sentence data, instead of the degree of cosine similarity, for example, the inner product or the Euclidean distance between the image vector of the candidate image data and the sentence vector of the search sentence data may be used. The inner product and the Euclidean distance of vectors can also be employed as calculation approaches for the degree of similarity with low cost of computation. When the inner product of vectors is used for the degree of similarity, the greater the value of the inner product, the higher the similarity. When the Euclidean distance of vectors is used for the degree of similarity, the smaller the Euclidean distance (the closer the distance), the higher the similarity. In addition, the degree of similarity between the image vector of the candidate image data and the sentence vector of the search sentence data may be an index value calculated based on two or more of the degree of cosine similarity, the inner product, and the Euclidean distance of the vectors.

Next, a configuration example of the user-side server 100 and a configuration example of the service provider-side server 200 according to the present embodiment will be described in order.

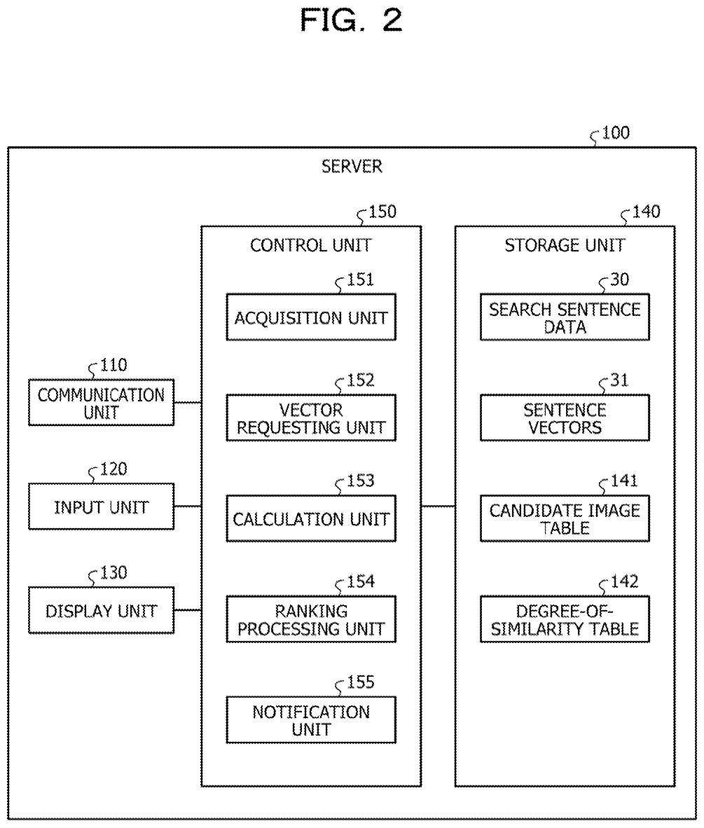

First, a configuration example of the user-side server 100 will be described. FIG. 2 is a functional block diagram illustrating a configuration of the user-side server according to the present embodiment. As illustrated in FIG. 2, the server 100 includes a communication unit 110, an input unit 120, a display unit 130, a storage unit 140, and a control unit 150.

The communication unit 110 executes data communication with the user terminal 20 and the server 200 via the network. The control unit 150 to be described later exchanges data with the user terminal 20 and the server 200 via the communication unit 110.

The input unit 120 is an input device that inputs various types of information to the control unit 150 of the server 100. The input unit 120 corresponds to a keyboard, a mouse, a touch panel, or the like.

The display unit 130 is a display device that displays information output from the control unit 150.

The storage unit 140 includes search sentence data 30, sentence vectors 31, a candidate image table 141, and a degree-of-similarity table 142. The storage unit 140 corresponds to a semiconductor memory element such as a random access memory (RAM) or a flash memory, or a storage device such as a hard disk drive (HDD).

The search sentence data 30 is text data accepted from the user terminal 20. For example, the search sentence data 30 is “dog running in the park”. The search sentence data 30 may be text data other than “dog running in the park”.

The sentence vector 31 is a vector calculated based on the search sentence data 30. The sentence vector 31 is calculated by the server 200.

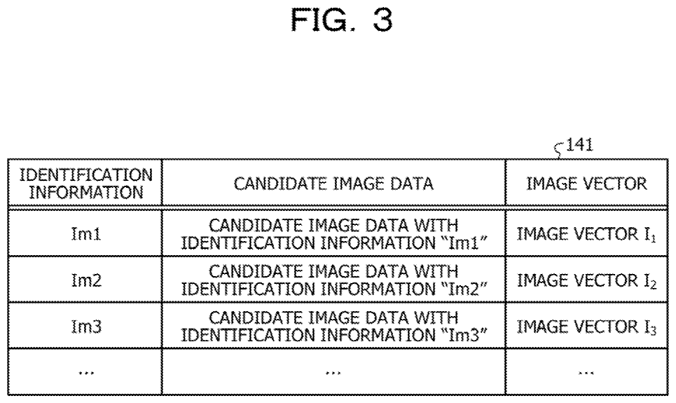

The candidate image table 141 holds information regarding candidate image data. FIG. 3 is a diagram illustrating an example of the data structure of the candidate image table. As illustrated in FIG. 3, this candidate image table associates identification information, candidate image data, and image vectors. The identification information is information that identifies the candidate image data. The candidate image data is image data to be compared in degree of similarity with the search sentence data. The image vector is a vector calculated based on the candidate image data. The image vector is calculated by the server 200.

In the following description, the candidate image data with the identification information “Imn” will be expressed as candidate image data Imn as appropriate. A natural number is denoted by n. For example, the candidate image data with the identification information Im1 will be expressed as candidate image data Im1.

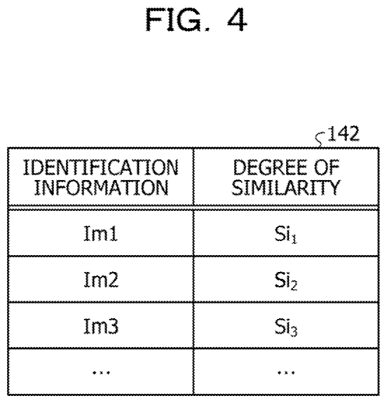

The degree-of-similarity table 142 is a table that holds information on the degrees of similarity between the sentence vector 31 and each image vector. FIG. 4 is a diagram illustrating an example of the data structure of the degree-of-similarity table. As illustrated in FIG. 4, this degree-of-similarity table 142 associates identification information and the degrees of similarity. The identification information is information that identifies the candidate image data. The degree of similarity indicates the degree of similarity between the image vector of the relevant candidate image data and the sentence vector 31. For example, the record on the first line in FIG. 4 indicates that the degree of similarity between the image vector of the candidate image data with the identification information Im1 and the sentence vector 31 is “Si₁”.

The description returns to FIG. 2. The control unit 150 includes an acquisition unit 151, a vector requesting unit 152, a calculation unit 153, a ranking processing unit 154, and a notification unit 155. The control unit 150 is implemented by a central processing unit (CPU), a graphics processing unit (GPU), or a hard-wired logic such as an application specific integrated circuit (ASIC) or a field programmable gate array (FPGA), or the like.

The acquisition unit 151 acquires the search sentence data 30 from the user terminal 20. The acquisition unit 151 stores the acquired search sentence data 30 in the storage unit 140. In the present embodiment, a case where the acquisition unit 151 acquires the search sentence data 30 from the user terminal 20 will be described, but the acquisition unit 151 may acquire the search sentence data from the input unit 120.

The vector requesting unit 152 transmits all candidate image data registered in the candidate image table 141 to the server 200 and requests the image vector of each piece of the candidate image data. For example, the vector requesting unit 152 transmits first request data to the server 200 when requesting the image vector of each piece of the candidate image data. The first request data includes all candidate image data registered in the candidate image table 141, and the identification information is assigned to each piece of the candidate image data.

When receiving the image vector of each piece of the candidate image data from the server 200 after transmitting the first request data, the vector requesting unit 152 stores the image vector of each piece of the candidate image data in the candidate image table 141 in association with the identification information. It is assumed that the identification information on the corresponding piece of the candidate image data is assigned to the image vector. The vector requesting unit 152 executes the above process in advance.

In addition, at the time point when the search sentence data 30 is stored in the storage unit 140 by the acquisition unit 151, the vector requesting unit 152 transmits the search sentence data 30 to the server 200 to request the sentence vector. When receiving the sentence vector 31 from the server 200, the vector requesting unit 152 stores the received sentence vector 31 in the storage unit 140.

The calculation unit 153 calculates the degree of similarity (degree of cosine similarity) between the image vector of each piece of the candidate image data stored in the candidate image table 141 and the sentence vector 31. The calculation unit 153 stores the calculated degree of similarity in the degree-of-similarity table 142 in association with the relevant identification information. For example, the calculation unit 153 registers the degree of similarity between the candidate image data Imn and the sentence vector 31 in the degree-of-similarity table 142 in association with the identification information “Imn”.

The calculation unit 153 repeatedly executes the above process for each image vector stored in the candidate image table 141.

The ranking processing unit 154 ranks candidate image data similar to the search sentence data 30, based on the degree-of-similarity table 142. For example, the ranking processing unit 154 sorts the identification information in the degree-of-similarity table 142 in descending order of the degree of similarity from the highest one and specifies the identification information from the highest rank to the N-th rank. The ranking processing unit 154 outputs the identification information from the highest rank to the N-th rank to the notification unit 155.

In addition, the ranking processing unit 154 acquires, from the candidate image table 141, the candidate image data corresponding to the identification information from the highest rank to the N-th rank. In the following description, the candidate image data corresponding to the identification information from the highest rank to the N-th rank will be expressed as “specified image data”.

The ranking processing unit 154 transmits second request data including N pieces of the specified image data and the search sentence data 30 to the server 200 to request the calculation of the degree of similarity. The identification information is assigned to the N pieces of the specified image data included in the second request data.

When receiving the degree of similarity between each piece of the specified image data and the search sentence data 30 from the server 200 after transmitting the second request data, the ranking processing unit 154 updates the degree of similarity corresponding to the identification information on the specified image data in the degree-of-similarity table 142, based on the received degrees of similarity.

After updating the degree-of-similarity table 142, the ranking processing unit 154 executes again ranking of the candidate image data similar to the search sentence data 30, based on the degree-of-similarity table 142, and outputs the identification information from the highest rank to the N-th rank to the notification unit 155.

The notification unit 155 accepts the identification information from the highest rank to the N-th rank from the ranking processing unit 154 and acquires the candidate image data corresponding to the accepted identification information from the candidate image table 141. The notification unit 155 notifies the user terminal 20 of the acquired candidate image data as processing results.

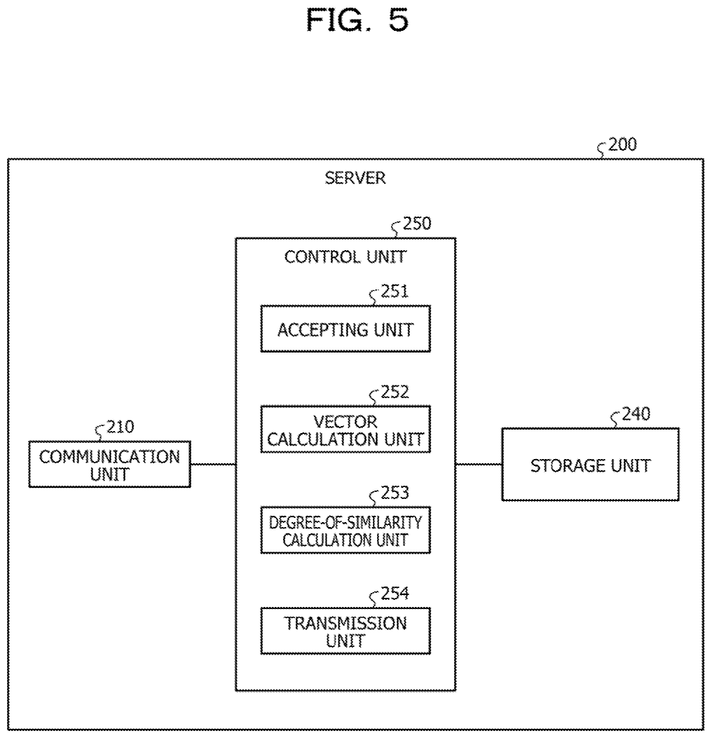

Subsequently, a configuration example of the service provider-side server 200 will be described. FIG. 5 is a functional block diagram illustrating a configuration of the service provider-side server. As illustrated in FIG. 5, the server 200 includes a communication unit 210, a storage unit 240, and a control unit 250.

The communication unit 210 executes data communication with the user-side server 100 via the network. The control unit 250 to be described later exchanges data with the server 100 via the communication unit 210.

The storage unit 240 stores various types of data used by the control unit 250. The storage unit 240 temporarily holds the candidate image data, the search sentence data 30, and the like transmitted from the server 100. The storage unit 240 corresponds to a semiconductor memory element such as a RAM or a flash memory, or a storage device such as an HDD.

The control unit 250 includes an accepting unit 251, a vector calculation unit 252, a degree-of-similarity calculation unit 253, and a transmission unit 254. The control unit 250 is implemented by a CPU, a GPU, or a hard-wired logic such as an ASIC or an FPGA, or the like.

The accepting unit 251 accepts various requests from the server 100. When receiving the first request data from the server 100, the accepting unit 251 outputs the first request data to the vector calculation unit 252. When receiving the search sentence data 30 from the server 100, the accepting unit 251 outputs the search sentence data 30 to the vector calculation unit 252. When receiving the second request data, the accepting unit 251 outputs the second request data to the degree-of-similarity calculation unit 253.

When accepting the first request data, the vector calculation unit 252 separately calculates the image vectors of the plurality of pieces of the candidate image data included in the first request data. The vector calculation unit 252 assigns the identification information on the corresponding piece of the candidate image data to each calculated image vector and outputs each image vector to the transmission unit 254. After calculating the image vectors, the vector calculation unit 252 deletes the candidate image data.

When accepting the search sentence data 30, the vector calculation unit 252 calculates the sentence vector 31 of the search sentence data 30. The vector calculation unit 252 outputs the calculated sentence vector 31 to the transmission unit 254. After calculating the sentence vector 31, the vector calculation unit 252 deletes the search sentence data 30.

For example, the vector calculation unit 252 uses a first training model (ViLBERT) described in the reference technique (Pretraining Task-Agnostic Visiolinguistic Representations for Vision-and-Language Tasks, arxiv.org) to calculate the image vector and the sentence vector. This first training model is trained such that the sentence vector of a certain sentence and the image vector of the image data corresponding to this certain sentence have similarity. For example, the parameters of the first training model are trained such that the sentence vector of a certain sentence “dog running in the park” and the image vector of image data containing a dog become similar vectors.

The vector calculation unit 252 calculates the image vector by inputting the candidate image data to the first training model. The vector calculation unit 252 calculates the sentence vector by inputting the search sentence data 30 to the first training model. Note that, when the candidate image data and sentence data are simultaneously input to the first training model, the image vector and the sentence vector are output.

When accepting the second request data, the degree-of-similarity calculation unit 253 separately calculates the degrees of similarity between the plurality of pieces of the specified image data (N pieces of the specified image data) included in the second request data and the search sentence data 30. For example, by inputting one piece of the specified image data and the search sentence data 30 to a second training model, the degree-of-similarity calculation unit 253 calculates the degree of similarity between this one piece of the specified image data and the search sentence data 30. This second training model is assumed to be trained in advance using a training data set in which a certain piece of image data and a certain piece of sentence data are used as input and the degree of similarity between this certain piece of image data and this certain piece of sentence data is treated as a correct answer label.

The degree-of-similarity calculation unit 253 assigns the identification information on the corresponding specified image data to the calculated plurality of degrees of similarity (N degrees of similarity) and outputs the plurality of degrees of similarity to the transmission unit 254. After calculating the degrees of similarity, the degree-of-similarity calculation unit 253 deletes each piece of the specified image data and the search sentence data 30.

When accepting a plurality of image vectors to which the identification information on each piece of the candidate image data is assigned, from the vector calculation unit 252, the transmission unit 254 transmits the plurality of image vectors to the server 100. After transmitting the plurality of image vectors to the server 100, the transmission unit 254 deletes the image vectors.

When accepting the sentence vector 31 of the search sentence data 30 from the vector calculation unit 252, the transmission unit 254 transmits the sentence vector 31 to the server 100. After transmitting the sentence vector 31 to the server 100, the transmission unit 254 deletes the sentence vector 31.

When accepting a plurality of degrees of similarity to which the identification information of each piece of the specified image data is assigned, from the degree-of-similarity calculation unit 253, the transmission unit 254 transmits the plurality of degrees of similarity to the server 100.

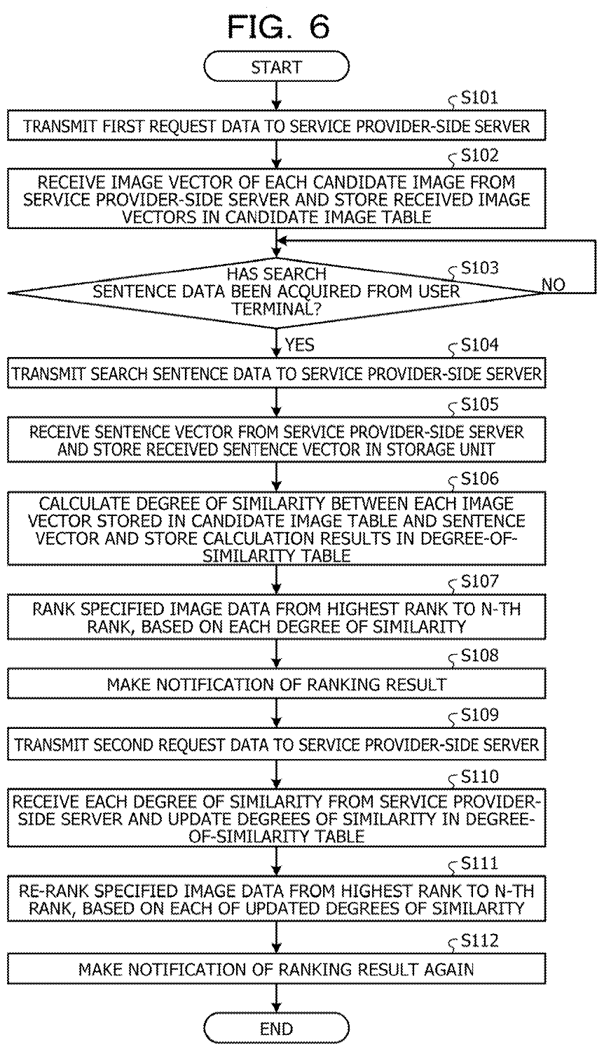

Next, an example of the processing procedure of the user-side server 100 illustrated in FIG. 2 will be described. FIG. 6 is a flowchart illustrating a processing procedure of the user-side server according to the present embodiment. As illustrated in FIG. 6, the vector requesting unit 152 of the server 100 transmits the first request data to the service provider-side server 200 (step S101). The vector requesting unit 152 receives the image vector of each candidate image from the service provider-side server 200 and stores the received image vectors in the candidate image table 141 (step S102).

When the acquisition unit 151 of the server 100 does not acquire the search sentence data 30 from the user terminal 20 (step S103, No), the process proceeds to step S103 again. On the other hand, when the acquisition unit 151 acquires the search sentence data 30 from the user terminal 20 (step S103, Yes), the process proceeds to step S104.

The vector requesting unit 152 transmits the search sentence data 30 to the service provider-side server 200 (step S104). The vector requesting unit 152 receives the sentence vector 31 from the service provider-side server 200 and stores the received sentence vector 31 in the storage unit 140 (step S105).

The calculation unit 153 of the server 100 calculates the degree of similarity between each image vector stored in the candidate image table 141 and the sentence vector and stores the calculation results in the degree-of-similarity table 142 (step S106).

The ranking processing unit 154 of the server 100 ranks the specified image data from the highest rank to the N-th rank, based on each degree of similarity (step S107). The notification unit 155 of the server 100 notifies the user terminal 20 of the ranking result (step S108).

The ranking processing unit 154 transmits the second request data to the service provider-side server 200 (step S109). The ranking processing unit 154 receives each degree of similarity from the service provider-side server 200 and updates the degrees of similarity in the degree-of-similarity table 142 (step S110).

The ranking processing unit 154 re-ranks the specified image data from the highest rank to the N-th rank, based on each of the updated degrees of similarity (step S111). The notification unit 155 notifies the user terminal 20 of the ranking result again (step S112).

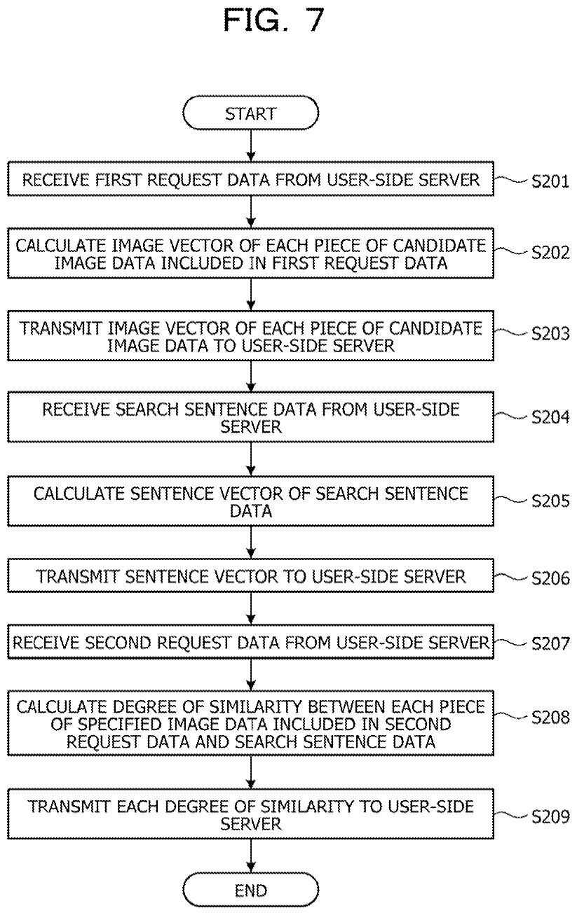

Next, an example of the processing procedure of the service provider-side server 200 illustrated in FIG. 5 will be described. FIG. 7 is a flowchart illustrating a processing procedure of the service provider-side server according to the present embodiment. As illustrated in FIG. 7, the accepting unit 251 of the server 200 receives first request data from the user-side server 100 (step S201).

The vector calculation unit 252 of the server 200 calculates the image vector of each piece of the candidate image data included in the first request data (step S202). The transmission unit 254 of the server 200 transmits the image vector of each piece of the candidate image data to the user-side server 100 (step S203).

The accepting unit 251 receives the search sentence data 30 from the user-side server 100 (step S204). The vector calculation unit 252 calculates the sentence vector 31 of the search sentence data 30 (step S205). The transmission unit 254 transmits the sentence vector 31 to the user-side server 100 (step S206).

The accepting unit 251 receives the second request data from the user-side server 100 (step S207). The degree-of-similarity calculation unit 253 of the server 200 calculates the degree of similarity between each piece of the specified image data included in the second request data and the search sentence data 30 (step S208). The transmission unit 254 transmits each degree of similarity to the user-side server 100 (step S209).

Next, effects of the information processing system according to the present embodiment will be described. The user-side server 100 prompts the server 200 to calculate the sentence vector when acquiring the search sentence data 30 as a search condition and receives the sentence vector notified by the server 200. The server 100 uses the received sentence vector and a plurality of image vectors acquired in advance from the server 200 to calculate the degrees of similarity between the search sentence data and the candidate image data and may achieve improvement in the efficiency of the calculation of the degree of similarity. For example, when the degree of similarity of each piece of candidate image data to the search sentence data is calculated, the user terminal 20 may be allowed to be notified of the processing results at high speed without preparing large-scale computational resources in the user-side server 100 and without imposing a network load.

In addition, when computing the degree of similarity, the server 100 computes the degree of cosine similarity between the image vector of the candidate image data and the sentence vector of the search sentence data. Meanwhile, the server 200 calculates the degree of similarity between the candidate image data and the search sentence data, by inputting the candidate image data and the search sentence data to a trained training model. The degree of cosine similarity has a low cost of computation, but has low accuracy compared with the calculation result for the degree of similarity by the training model. The server 100 notifies the user terminal 20 of the ranking result based on the degree of cosine similarity and transmits the second request data to the server 200 to receive a more accurate degree of similarity. When the server 100 performs such a process, the ranking result according to the degree of cosine similarity can be notified first, and the ranking result can be modified later according to the results of using the training model, which may allow the user terminal 20 to be notified of more precise ranking information.

Incidentally, the information processing system described above is an example and is not limited to the information processing system in FIG. 1, for example. Hereinafter, other examples of the information processing system will be described.

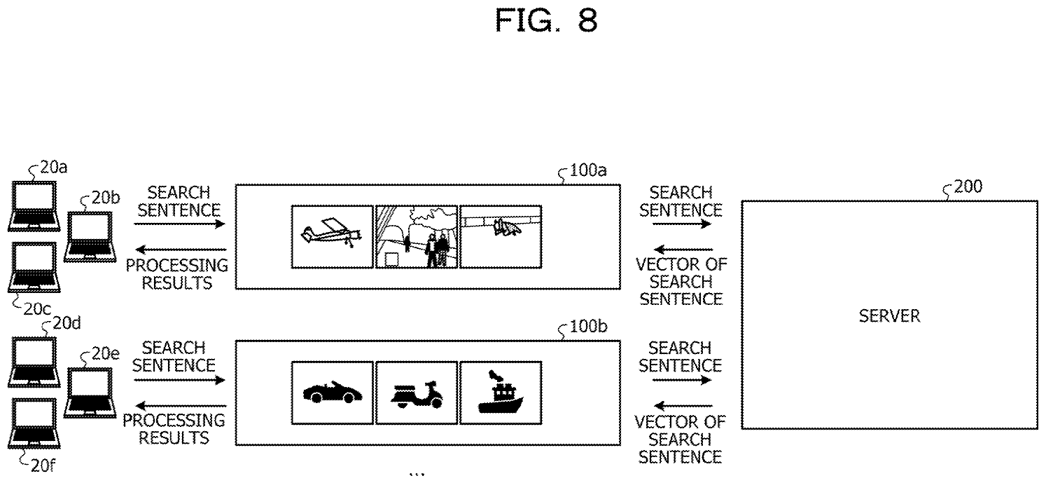

FIG. 8 is a diagram (1) illustrating another example of the information processing system. As illustrated in FIG. 8, this information processing system includes a plurality of user-side servers. For example, the user-side servers are assumed to be servers 100a and 100b. The server 100a acquires the search sentence data from user terminals 20a, 20b, and 20c and executes the process corresponding to the server 100 described with reference to FIG. 2. The server 100b acquires the search sentence data from user terminals 20d, 20e, and 20f and executes the process corresponding to the server 100 described with reference to FIG. 2. The server 200 accepts requests for the vector calculation and the calculation of the degree of similarity from the servers 100a and 100b and transmits the calculation results to the servers 100a and 100b.

By adopting the configuration of the information processing system in FIG. 8, the candidate image data independent of each other may be stored for each of certain groups of user terminals, and each of certain groups of user terminals may be notified of the ranking result corresponding to the search sentence data. For example, the information processing system in FIG. 8 is effective when the user terminals 20a to 20c and the user terminals 20d to 20f are not permitted to share the candidate image data.

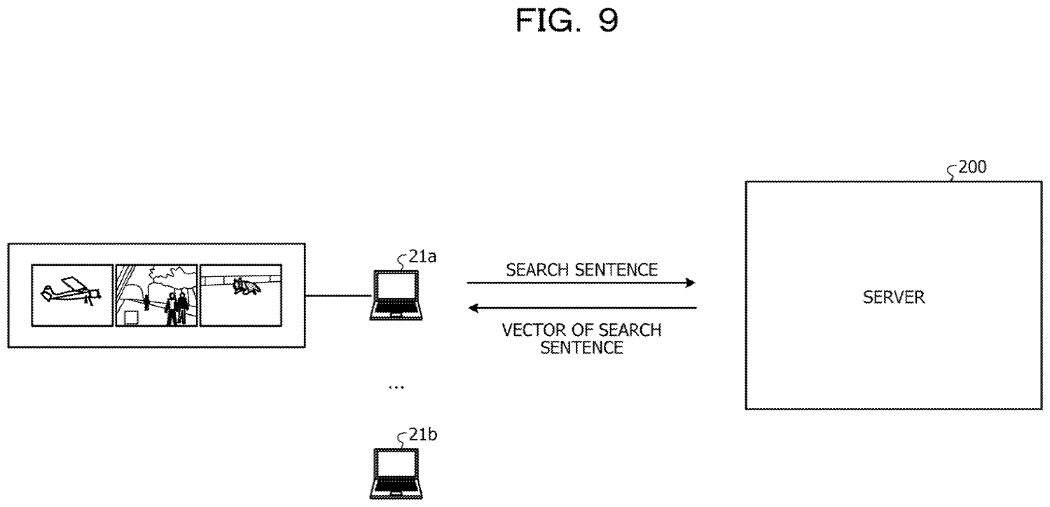

FIG. 9 is a diagram (2) illustrating another example of the information processing system. As illustrated in FIG. 9, this information processing system includes user terminals 21a and 21b and a server 200. The user terminals 21a and 21b have functions similar to the function of the server 100 described with reference to FIG. 2 and performs data communication directly with the server 200, instead of the server 100. The server 200 may notify the user terminals 21a and 21b of a program for executing a process similar to the process of the server 100 and cause the user terminals 21a and 21b to execute the program.

For example, the user terminal 21a transmits the first request data to the server 200 and receives the image vectors of the candidate image data in advance. In addition, the search sentence data is transmitted to the server 200, the sentence vectors are received, and the degree of similarity between each image vector and the sentence vector is calculated and ranked. The user terminal 21b also executes a process similar to the process of the user terminal 21a.

By adopting the configuration of the information processing system in FIG. 9, each user terminal may obtain the ranking result even when the candidate image data independent of each other is stored for each user terminal.

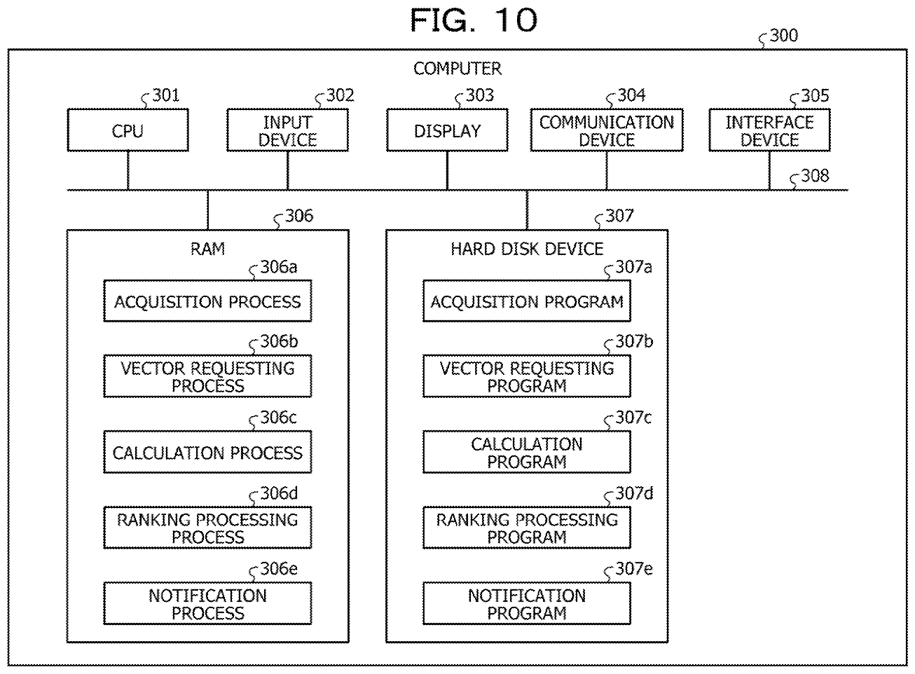

Next, an example of the hardware configuration of a computer that implements functions similar to the functions of the user-side server 100 described above will be described. FIG. 10 is a diagram illustrating an example of the hardware configuration of a computer that implements functions similar to the functions of the user-side server according to the embodiment.

As illustrated in FIG. 10, a computer 300 includes a CPU 301 that executes various arithmetic processes, an input device 302 that accepts input of data from a user, and a display 303. In addition, the computer 300 includes a communication device 304 that exchanges data with an external device or the like via a wired or wireless network, and an interface device 305. In addition, the computer 300 includes a RAM 306 that temporarily stores various types of information, and a hard disk device 307. Then, each of the devices 301 to 307 is coupled to a bus 308.

The hard disk device 307 has an acquisition program 307a, a vector requesting program 307b, a calculation program 307c, a ranking processing program 307d, and a notification program 307e. In addition, the CPU 301 reads each of the programs 307a to 307e to load each of the programs 307a to 307e into the RAM 306.

The acquisition program 307a functions as an acquisition process 306a. The vector requesting program 307b functions as a vector requesting process 306b. The calculation program 307c functions as a calculation process 306c. The ranking processing program 307d functions as a ranking processing process 306d. The notification program 307e functions as a notification process 306e.

The processing of the acquisition process 306a corresponds to the processing of the acquisition unit 151. The processing of the vector requesting process 306b corresponds to the processing of the vector requesting unit 152. The processing of the calculation process 306c corresponds to the processing of the calculation unit 153. The processing of the ranking processing process 306d corresponds to the processing of the ranking processing unit 154. The processing of the notification process 306e corresponds to the processing of the notification unit 155.

Note that each of the programs 307a to 307e do not necessarily have to be stored in the hard disk device 307 previously. For example, each of the programs is stored beforehand in a “portable physical medium” to be inserted in the computer 300, such as a flexible disk (FD), a compact disc read only memory (CD-ROM), a digital versatile disc (DVD), a magneto-optical disk, or an integrated circuit (IC) card. Then, the computer 300 may read and execute each of the programs 307a to 307e.

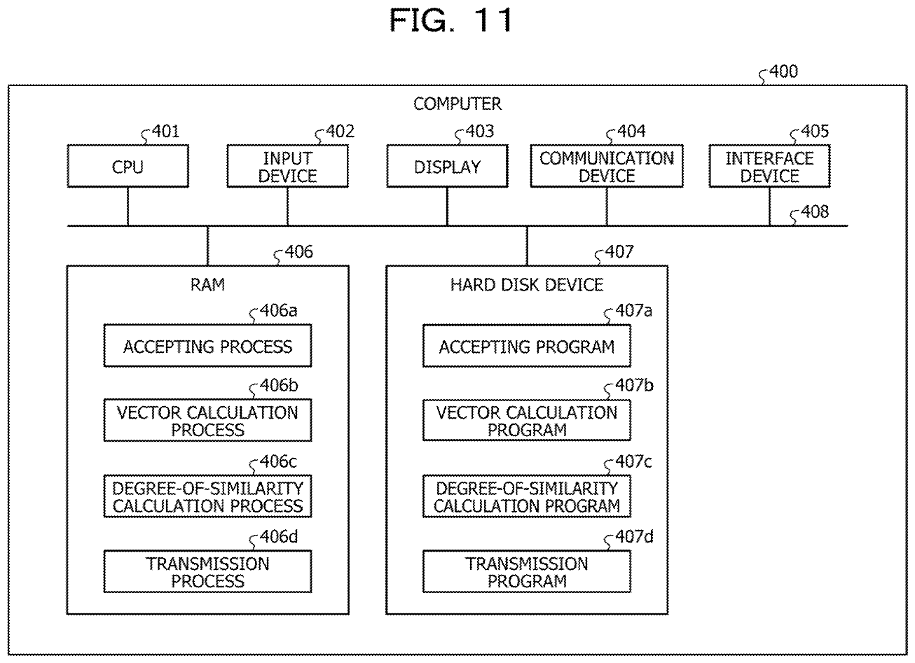

An example of the hardware configuration of a computer that implements functions similar to the functions of the service provider-side server 200 described above will be described. FIG. 11 is a diagram illustrating an example of the hardware configuration of a computer that implements functions similar to the functions of the service provider-side server according to the embodiment.

As illustrated in FIG. 11, a computer 400 includes a CPU 401 that executes various arithmetic processes, an input device 402 that accepts input of data from a user, and a display 403. In addition, the computer 400 includes a communication device 404 that exchanges data with an external device or the like via a wired or wireless network, and an interface device 405. In addition, the computer 400 includes a RAM 406 that temporarily stores various types of information, and a hard disk device 407. Then, each of the devices 401 to 407 is coupled to a bus 408.

The hard disk device 407 has an accepting program 407a, a vector calculation program 407b, a degree-of-similarity calculation program 407c, and a transmission program 407d. In addition, the CPU 401 reads each of the programs 407a to 407d to load each of the programs 407a to 407d into the RAM 406.

The accepting program 407a functions as an accepting process 406a. The vector calculation program 407b functions as a vector calculation process 406b. The degree-of-similarity calculation program 407c functions as a degree-of-similarity calculation process 406c. The transmission program 407d functions as a transmission process 406d.

The processing of the accepting process 406a corresponds to the processing of the accepting unit 251. The processing of the vector calculation process 406b corresponds to the processing of the vector calculation unit 252. The processing of the degree-of-similarity calculation process 406c corresponds to the processing of the degree-of-similarity calculation unit 253. The processing of the transmission process 406d corresponds to the processing of the transmission unit 254.

Note that each of the programs 407a to 407d do not necessarily have to be stored in the hard disk device 407 previously. For example, each of the programs is stored beforehand in a “portable physical medium” to be inserted in the computer 400, such as a flexible disk (FD), a CD-ROM, a DVD, a magneto-optical disk, or an IC card. Then, the computer 400 may read and execute each of the programs 407a to 407d.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing an information processing program that causes at least one computer to execute a process, the process comprising:
receiving, from a server, a plurality of pieces of first feature data that correspond to each of a plurality of pieces of image data;
acquiring text data included in search conditions, the search conditions being transmitted from a client device;
receiving second feature data that corresponds to the text data and is transmitted from the server, in response to transmitting the text data to the server; and
acquiring a plurality of degrees of similarity between the plurality of pieces of the first feature data and the second feature data.

2. The non-transitory computer-readable recording medium according to claim 1, wherein the process further comprising
outputting the plurality of degrees of similarity to the client device.

3. The non-transitory computer-readable recording medium according to claim 1, wherein
the first feature data and the second feature data are vector data, and
the acquiring the plurality of degrees of similarity includes acquiring the plurality of degrees of similarity based on at least one selected from a plurality of degrees of cosine similarity, an inner product, and a Euclidean distance between the plurality of pieces of the first feature data and the second feature data.

4. The non-transitory computer-readable recording medium according to claim 1, wherein the process further comprising
selecting first image data that corresponds to a second plurality of pieces of the first feature data includes feature data with a maximum degree of similarity among the plurality of degrees of similarity;
transmitting the first image data and the text data to the server;
receiving a second plurality of degrees of similarity between the first image data and the text data acquired by the server; and
modifying the plurality of degrees of similarity according to the second plurality of degrees of similarity.

5. An information processing method for a computer to execute a process comprising:
receiving, from a server, a plurality of pieces of first feature data that correspond to each of a plurality of pieces of image data;
acquiring text data included in search conditions, the search conditions being transmitted from a client device;
receiving second feature data that corresponds to the text data and is transmitted from the server, in response to transmitting the text data to the server; and
acquiring a plurality of degrees of similarity between the plurality of pieces of the first feature data and the second feature data.

6. The information processing method according to claim 5, wherein the process further comprising
outputting the plurality of degrees of similarity to the client device.

7. The information processing method according to claim 5, wherein
the first feature data and the second feature data are vector data, and
the acquiring the plurality of degrees of similarity includes acquiring the plurality of degrees of similarity based on at least one selected from a plurality of degrees of cosine similarity, an inner product, and a Euclidean distance between the plurality of pieces of the first feature data and the second feature data.

8. The information processing method according to claim 5, wherein the process further comprising
selecting first image data that corresponds to a second plurality of pieces of the first feature data includes feature data with a maximum degree of similarity among the plurality of degrees of similarity;
transmitting the first image data and the text data to the server;
receiving a second plurality of degrees of similarity between the first image data and the text data acquired by the server; and
modifying the plurality of degrees of similarity according to the second plurality of degrees of similarity.

9. An information processing device comprising:
one or more memories; and
one or more processors coupled to the one or more memories and the one or more processors configured to:
receive, from a server, a plurality of pieces of first feature data that correspond to each of a plurality of pieces of image data,
acquire text data included in search conditions, the search conditions being transmitted from a client device,
receive second feature data that corresponds to the text data and is transmitted from the server, in response to transmitting the text data to the server, and
acquire a plurality of degrees of similarity between the plurality of pieces of the first feature data and the second feature data.

10. The information processing device according to claim 9, wherein the one or more processors are further configured to
output the plurality of degrees of similarity to the client device.

11. The information processing device according to claim 9, wherein
the first feature data and the second feature data are vector data,
wherein the one or more processors are further configured to
acquire the plurality of degrees of similarity based on at least one selected from a plurality of degrees of cosine similarity, an inner product, and a Euclidean distance between the plurality of pieces of the first feature data and the second feature data.

12. The information processing device according to claim 9, wherein the one or more processors are further configured to:
select first image data that corresponds to a second plurality of pieces of the first feature data includes feature data with a maximum degree of similarity among the plurality of degrees of similarity,
transmit the first image data and the text data to the server,
receive a second plurality of degrees of similarity between the first image data and the text data acquired by the server, and
modify the plurality of degrees of similarity according to the second plurality of degrees of similarity.
